(19) United States
(12) Patent Application Publication
(10) Pub. No.: US 2010/0046748 A1
(43) Pub. Date: Feb. 25, 2010

(54) SYSTEM AND METHOD FOR DIGITAL DATA VALIDATION

(76) Inventors: Budi Kusnoto, Chicago, IL (US); Yunqing Pan, Oak Lawn, IL (US)

Correspondence Address: QUARLES & BRADY LLP, RENAISSANCE ONE, TWO NORTH CENTRAL AVENUE, PHOENIX, AZ, 85004-2391, US

(21) Appl. No.: 12/606,718

(22) Filed: Oct. 27, 2009

Related U.S. Application Data
(63) Continuation-in-part of application No. 10/949,171, filed on Sep. 24, 2004.
(60) Provisional application No. 60/506,564, filed on Sep. 26, 2003.

(51) Int. Cl. H04L 9/00; G06F 21/20

(52) U.S. Cl. 380/42; 726/7

(57) ABSTRACT

A memory card is presented. The memory card includes a storage medium for storing data. The memory card also includes a processor electronically coupled to the storage medium. The processor is configured to receive a data stream from a digital imaging device, and analyze the data stream to detect a pre-determined signal from the digital imaging device. When the pre-determined signal is detected in the data stream, the processor is configured to retrieve digital image data from the data stream, encrypt the digital image data, and store the encrypted digital image data on the storage medium.

### CROSS-REFERENCE TO RELATED APPLICATIONS

This application is based on, claims the benefit of, and incorporates by reference U.S. Provisional Application Ser. No. 60/506,564 filed Sep. 26, 2003 by Budi Kusnoto and Yunqing Pan, and entitled “DIGITAL IMAGE VALIDATION SYSTEM (DIVA)” and is a continuation-in-part of U.S. patent application Ser. No. 10/949,171 filed September 24 by Budi Kusnoto and Yunqing Pan, 2004 and entitled “DIGITAL IMAGE VALIDATION SYSTEM (DIVA).”

### FIELD OF THE INVENTION

The present invention relates generally to digital programmable memory and more specifically, to validation of data stored in programmable memory.

### BACKGROUND OF THE INVENTION

Digital cameras and other digital imaging devices (such as digital x-ray machines, digital laser scanners, and the like) are able to take photographs of, or otherwise image a subject and store the resulting image as digital data using digital image file formats such as .JPG, .TIFF, or .RAW. Unlike film-based imaging systems, after storing the digital image data the data can easily be manipulated or modified using widely available imaging editing software. In some cases, the modifications can be subtle or otherwise difficult to detect. As a result, it can be difficult, or even impossible, to detect the modifications with the human eye. In some cases, the modification of a digital image can be used for dishonest or even illegal purposes, such as in insurance fraud, or to provide fake evidence in a legal matter. Various technological solutions, including hardware and software solutions, have been presented in the past to prevent such changes to digital images.

Known approaches for protecting digital image data include the insertion of image meta-data into the digital image. Meta-data, such as exchangeable image file format (Exif) data, may include image header information stored in the digital image file that includes data such as picture taking conditions and various camera settings, such as camera model, ISO, shutter speed, aperture number, white balance, etc. Because the meta-data includes unprotected image data, however, the meta-data information can be easily accessed and modified. As a result, if changes are made to a particular image, the meta-data may be modified to mask any such changes.

Alternatively, digital signatures and watermarks may be inserted into a digital image to prevent tampering. After an author or publisher “signs” or “watermarks” a digital image by embedding a signature or watermark code into the image, other people can no longer change the images without authorization—usually provided in the form of a key or password. These techniques, however, are generally directed towards software to protect the copyright of digital images and are not readily applicable to protect the authenticity of an image. In the case of signatures or watermarks, the signature or watermark can simply be added to an image file after it has been tampered with, rather than before.

In yet another approach, application-specific secure digital imaging devices and secure memory cards may be used. These technologies require a user to purchase a specific camera that is only configured to create protected image data on a specific secure memory card. Using that particular combination of equipment (camera and memory card), after an image has been captured and stored on the memory card, it can no longer be modified. In some cases, however, a user may perform some basic modifications such as resizing, tilting, changing color depth (as well as brightness and contrast adjustment). This approach, however, requires that the user purchase a very specific model of digital imaging device and memory card, greatly limiting the user's options.

Therefore, there is a need to address the difficulties set forth above and others previously experienced.

### SUMMARY OF THE INVENTION

In one implementation, the present invention is a method of digital image validation. The method includes receiving a data stream from a digital imaging device, and analyzing the data stream to detect a pre-determined signal from the digital imaging device. When the pre-determined signal is detected in the data stream, the method includes retrieving digital image data from the data stream, encrypting the digital image data to generate encrypted digital image data, and storing the encrypted digital image data on a storage medium.

In another implementation, the present invention is a memory card. The memory card includes a storage medium for storing data, and a processor electronically coupled to the storage medium. The processor is configured to receive a data stream from a digital imaging device, and analyze the data stream to detect a pre-determined signal from the digital imaging device. When the pre-determined signal is detected in the data stream, the processor is configured to retrieve digital image data from the data stream, encrypt the digital image data, and store the encrypted digital image data on the storage medium.

In another implementation, the present invention is a digital imaging system including a digital imaging device. The digital imaging device is configured to transmit a pre-determined signal. The digital imaging system includes a storage device configured in electrical communication with the digital imaging device. The storage device includes a storage medium for storing data, and a processor electronically coupled to the storage medium. The processor is configured to receive a data stream from the digital imaging device, and analyze the data stream to detect a pre-determined signal from the digital imaging device. When the pre-determined signal is detected in the data stream, the processor is configured to retrieve digital image data from the data stream, encrypt the digital image data, and store the encrypted digital image data on the storage medium.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 illustrates a digital image validation system in a Compact Flash small form factor;

FIG. 2 illustrates a core processor unit of the digital image validation system shown in FIG. 1;

FIG. 3 illustrates another implementation of the core processor unit of FIG. 2 embedded in a Dongle form factor;

FIG. 4 is a flow diagram of the monitoring data traffic and firmware update for the digital image validation system of FIG. 1;

FIG. 5 is a flow diagram of decryption of digital images stored in the Compact Flash of FIG. 1;

FIG. 6 is a diagram of an application for remote digital image validation and firmware update;

FIG. 7 is an illustration of a system for image validation including an image validation memory card, imaging device, computer system, and website;

FIG. 8 is an illustration of some of the functional components comprising the present DIVA memory card;

FIG. 9 is a schematic diagram showing additional detail of the components of an exemplary core processor of the present memory card;

FIG. 10 is a flowchart showing an example method for interfacing the present memory card with a device to receive image data and store encrypted image data within the memory card;

FIG. 11 is an illustration of an exemplary data warehouse infrastructure for receiving encrypted image files, decrypting the image files, and displaying comparison images for a user to verify whether a particular image has been modified;

FIG. 12 is a flowchart showing an example method for a user to retrieve encrypted image files from the memory card of the present disclosure and upload the encrypted image files to a website for decryption;

FIG. 13 is a flowchart showing an example method for verifying the authenticity of an unencrypted image file created using the method of FIG. 10;

FIGS. 14a-14c illustrate a user interface allowing a user to upload an encrypted image file to a data warehouse infrastructure, such as the warehouse illustrated in FIG. 11; and

FIGS. 15a-15c illustrate a user interface for uploaded an image to verify the authenticity of the image.

### DETAILED DESCRIPTION OF THE DRAWINGS

Systems and methods to secure digital images or other data consistent with the present disclosure may be adapted to permanent or removable memory, such as COMPACTFLASH devices, SMART MEDIA devices, or similar portable storage media (such as a dongle or key, PCMCIA storage media, controller integrated memory devices, etc). The memory may be configured to be compatible with digital cameras but may be used in other image generating/obtaining digital devices (such as digital radiography, CT-Scan, Digital Video, etc). In one implementation, the present system is configured to use a COMPACT FLASH form factor that complies with the specifications of both CF/CF+ card and digital camera data interfaces as set forth by CFA (Compact Flash Association) and JEIDA (Japan Electronic Industry Development Association).

Other embodiments may also be implemented/manufactured in different form factors that give more freedom in shapes, adaptabilities and functions such as being powered by external or internal power sources such as a USB port, small computer system interface (SCSI) port or other connections that can also be used as a power source. Further development and application of embodiments of the invention may enable different kinds of devices that produce digital image data to share or use removable memory while securing the digital images contained on the media. Compression functions can be embedded into the memory devices as well as the encryption function to preserve more space within the memory device.

The current embodiment may fit into a digital camera's Compact Flash card adaptor or any other digital imaging device using Compact Flash memory as storage media. In other embodiments, other types of removable memory media may be employed. The hardware may be a Compact Flash card (in both type I and type II). As described in the CF+ and Compact Flash Specification Revision 1.4, a CF or CF+ card may have a controller processor(s) between the host interface and the I/O modules. In the current embodiment, the validation, encryption and duplication tasks may be done in the controller processor. Also the host interface for reading and writing may be 100% compliant with the Compact Flash specification that may be controlled by the controller processor.

A digital image validation system card of the present system may be equipped with a unique serial number and encryption technology, such as a 40, 56, 64, or 128-bit encryption key and other encryption keys that may use either security key or public key methods. In another embodiment, identical public key methods may be used by assigning identical keys to every card. The serial number may be a manufacturer item control number and may be available to everyone, e.g. “S/N: ECO000001” printed on the cover/casing of the small form factor.

The encryption key may be used to perform the encryption of image data. The encryption may conform to public and/or security key algorithms such as the Rivest, Shamir, and Adleman (RSA) algorithm (public key based), Data Encryption Standard (DES) and/or Advanced Encryption Standard (AES) (security key based) as set forth by NIST (National Institute of Standards and Technologies). The encryption key may be built into a chip of the card so that users have no access to the encryption key. It may be preferable, for example, that only the manufacturer knows the corresponding encryption key assigned to each individual card that is stored in a secure database on a digital image validation system server site.

Upon encryption, the binary data may undergo data compression using deflate or other similar compression algorithms. The memory card with digital image validation system is available for writing information only when the memory card is residing in a camera and the camera is in the picture-taking mode. Thus only the original data coming directly from the camera processor will be written onto the memory card. This may be done through the communication between the camera and the core processor.

According to JEIDA's (Japan Electronic Industry Development Association) digital camera specification documents, each time an imaging device (e.g., a digital camera) is powered on, whether in picture-taking or picture-viewing mode, the imaging device will first check whether the desired file system is present in the memory storage media. Depending upon the system implementation, the file system may be ROOT/DCIM/AAAA#### (‘A’ stands for any upper-case letter, and ‘#’ stands for any number from 0-9). If the folder is not present on the device, a writer/reader of the imaging device creates one on the memory card. There will be no specific file system checking when a memory card is working in either a universal card reader or the camera memory slot as the camera is in universal serial bus (USB) transmission mode.

Accordingly, each time the present DIVA memory card is powered on, the memory card monitors its communication interfaces to detect the folder-locating signal from the card's interface before disabling the write protector. After the card receives the signal (indicating that the card is inserted into a digital imaging device), write protection may be disabled to allow the image data to be written until the next power off. When the image data is input to the memory card, the duplicator module in the controller of the memory card starts to function. While writing the image data on the storage module of the memory card, the controller makes a duplicate onto the controller's own buffer. Then the compressor-encryptor takes the image from the buffer, uses the encryption key to encrypt the image into an encrypted file (e.g., a *.DIV file), and then stores the encrypted image file onto the memory of the memory card.

When transferring data out of the DIVA memory card, the user plugs the memory card into a universal card reader and performs normal copy-and-paste of one or more of the stored files, including both original and verified (e.g., encrypted) files. Because erasing files or formatting the memory card requires information to be written on to the storage media, this task can only be done in the camera using the camera's default erase/format options.

The DIVA core processor may be a microprocessor such as a digital signal processor (DSP), a collection of discrete logic or analog circuits that implement a state machine, an application specific integrated circuit (ASIC), or a combination of the above. The DIVA core processor includes a background application to monitor flow of data from and through the image capture hardware peripheral connected directly to the CPU via PCMCIA/SCSI/Parallel/Serial/USB/Firewire or other types of connections.

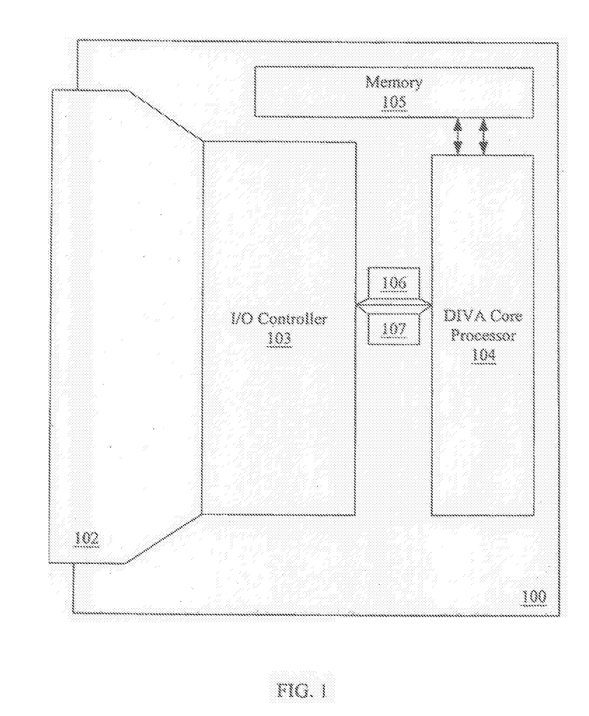

Turning to FIG. 1, one implementation of a DIVA system implemented in a Compact Flash form factor 100 is illustrated. The Compact Flash form factor 100 may have standard Compact Flash dimensions (42 millimeters (mm) by 36 mm by 3.5 mm) or, in other embodiments, may have other form-factor housings such as dongles, or PCMCIA form factors including other data connector types such as SCSI, Parallel, Serial, USB, or Firewire. A standard Compact Flash input/output (I/O) connector may include 50 pin connector 102 located along an edge of the Compact Flash DIVA memory card. DIVA memory card 100 may also have an I/O controller 103 coupled to the connector, digital image validation core processor 104, memory 105, and buffers 106 and 107. Image data is received from an imaging device using connector 102, and passed through I/O interface controller 103 and through channels 106 and 107 to the DIVA core processor 104 for processing. The image data is then stored in or retrieved from memory 105 by DIVA core processor 104. In other embodiments, the blocks representing processors and controllers may be combined or further broken down by function.

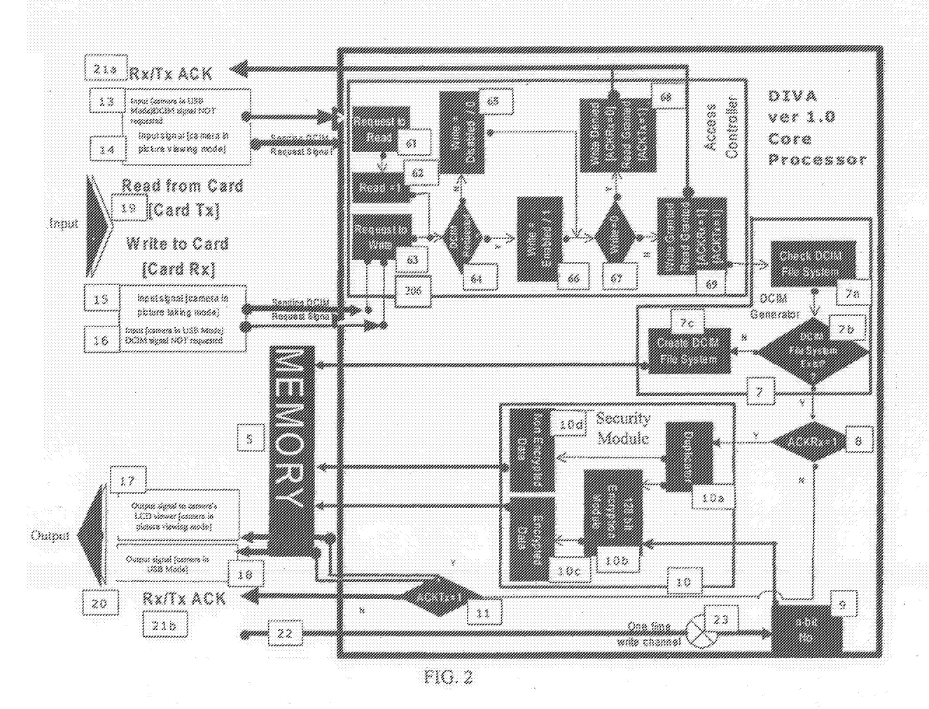

In FIG. 2, core processor unit 104 of the digital image validation system of FIG. 1 is shown. DIVA access controller 206 grants or denies writing access to the memory 105 based upon various criteria. The READING of information/data stored in memory 105 (shown on FIG. 1) requires the input pin from I/O interface controller 103 (shown on FIG. 1) send a signal requesting authorization to begin READING data from memory 105 (shown on FIG. 1).

When a digital device such as a digital camera is set to be in picture viewing mode 14, the camera sends a digital camera images (DCIM) request signal (DCIMRS) to the DIVA processor. In other cases, no DCIMRS may be sent, such as when data is requested by USB mode 13. I/O controller 103 (see FIG. 1) may patch input signals 13, 14, 15 and 16 through channel 106 (see FIG. 1) to the DIVA core processor 104. The DIVA access controller 206 may then grant a READ.

The WRITING of information/data to memory 105 (shown on FIG. 1) occurs when the input pin from I/O Interface Controller 103 (shown on FIG. 1) sends a signal requesting authorization to begin WRITING data to memory 105 (shown on FIG. 1). The request may come from a camera in picture taking mode 15 or USB mode 16. When the signal comes from the camera in picture taking mode 15, the DCIMRS will be sent, otherwise no DCIMRS is sent. The I/O Interface controller 103 (shown on FIG. 1) may perform checking of the DCIMRS. Upon receiving a DCIMRS, WRITE access may be granted (WRITE=Enabled/1) 66, otherwise WRITE may not be granted (WRITE=Disabled/0).

In order for WRITE access to be enabled, i.e. for WRITE=Enabled/1, the WRITE status must be checked. If WRITE access=Enabled then the process will go to 69, otherwise the process goes to 68. If WRITE access is denied, ACKRx is set to 0 in 21a then the ACKNOWLEDGE RECEIVING signal to the I/O interface controller 103 (shown on FIG. 1) is disabled. If READ is granted, ACKTx is set to 1 in 21a to indicate enablement and the ACKNOWLEDGE TRANSMITTING signal to the I/O interface controller 103 is present. Granting both WRITE and READ access requires that both ACKRx 21a and ACKTx 21a value will be 1 (enabled).

The core processor 104 (shown in FIG. 1) will check the existence of a DCIM file system in memory 105 upon a request being sent by process 14 and 15 after being checked and granted by the access controller 206. If the DCIM file system already exists in memory 105 then ACKRx is enabled, or set to 1, otherwise a DCIM file system is created. Creation of the DCIM file system and the writing of the DCIM file system to memory 105 (shown on FIG. 1) requires the ACKRx signal 21a. If the ACKRx signal is enabled (i.e.=1), then the system processes may continue to the security module 10, otherwise ACKTx=1 11.

Each DIVA card in the present embodiment may have CMOS memory cells containing an n-bit unique serial number (S/N) that is unique for each DIVA card. The n-bit S/N may be stored during manufacture of the processor by means of writing the n-bit S/N data 22 through one time write channel 23. In other embodiments, other permanent memory methods may be employed. Security module 10 may include duplicator 10a. Duplicator 10 makes copies of every bit of a received signal. The copy of the data generated by duplicator 10a is passed through the encryption module 10b, which received the encryption code from 9. The encryption module 10b creates encrypted data 10c. The original data is then passed directly to non-encrypted data output 10d from duplicator 10a.

The ACKTx value 21a generated by access controller 206 controls execution of the security module. If ACKTx=1 is enabled, then the reading of data from memory 105 (shown on FIG. 1) through channel 17 for output to digital camera LCD viewer OR channel 18 for output to USB mode (USB Channel), otherwise ACKTx=1 11 will return the ACKTx value to the system 21b. Both channel 17 and 18 will output through the output channel 107 to the I/O interface controller 103 (shown on FIG. 1).

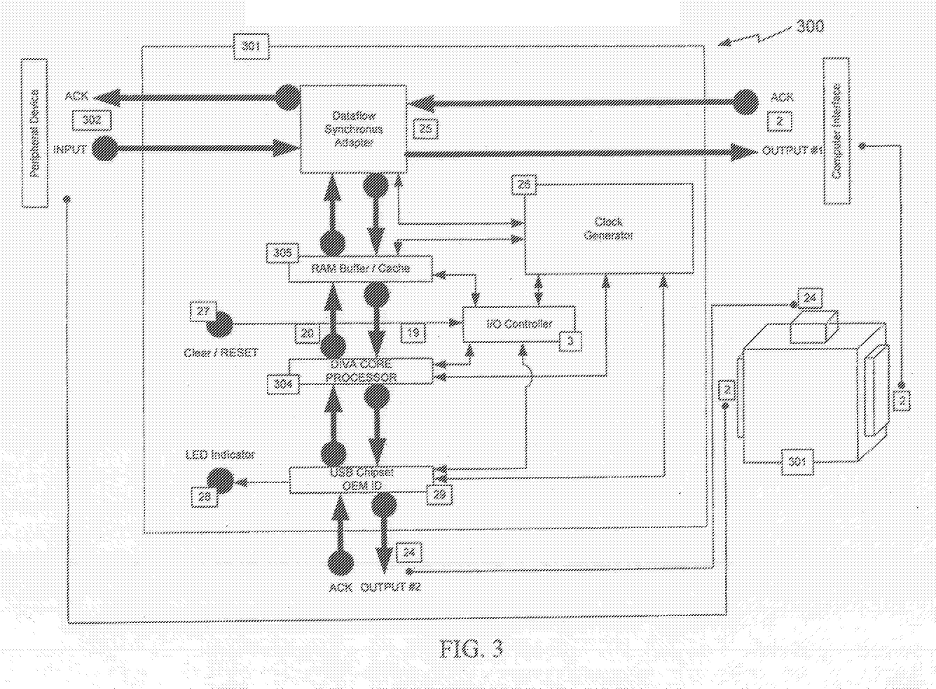

Turning to FIG. 3, another implementation of the core processor unit of FIG. 2 embedded in a dongle form factor 301 is illustrated. The dongle may also have one or more connectors 302 for connecting the dongle to electronic devices. An I/O controller 303 interfaces between the connector 302 and the different interfaces 302 and 24 via miscellaneous circuitry including a DIVA core processor 304 and RAM buffer/cache 305.

The secondary output channel 24 (e.g., USB, SCSI, Firewire, etc.) acts to pass the encrypted data copy generated by the DIVA core processor to other storage media (such as a hard drive DIVA card 301 attached). The dataflow synchronous adapter 25 is used to synchronize data flow between the pass-through of the primary output channel (original data 502) and data that will be processed/encrypted at a DIVA core processor 504.

The current implementation of DIVA for imaging peripheral devices may operate at high speed to handle and process large amounts of data such as CT-scan or other 3D imaging data. A clock generator 26 generates timing signals that are used to synchronize all processes, and may be used in self-powered embodiments.

In some implementations, a clear/RESET button 27 may function to clear memory/buffer information such that erasing the data can not be done externally and a ready LED indicator may be employed to indicate when the dongle is at work (green), busy (blinking green) or not working (red). Furthermore, an original equipment manufacturer (OEM) ID Chipset may store unique information as well as have a controller to link the DIVA card to a software driver. This unique information may later be used by firmware updates to upgrade the DIVA card security/encryption key as well as encryption algorithm.

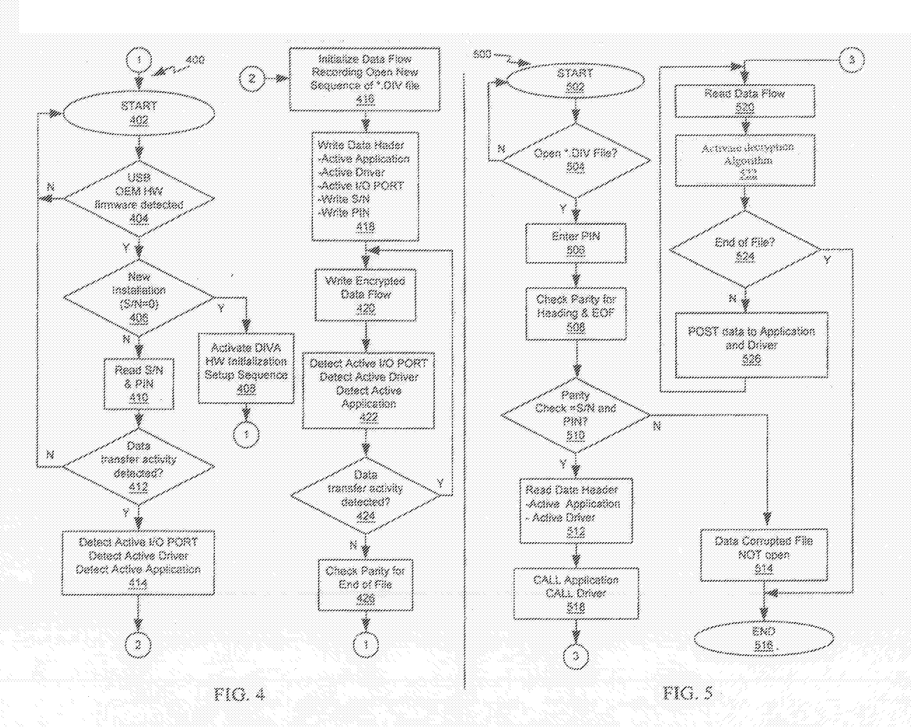

Turning to FIG. 4, a flow diagram 400 of monitoring data traffic and firmware updating for the digital image validation system of FIG. 1 is shown. The flow starts 402 with the USB OEM H/W firmware being detected 404. If the USB OEM H/W firmware is detected 404, then a determination is made as to the presence of a new installation 406. Otherwise, processing starts again 402.

If a new installation is detected 406, then DIVA H/W initialization setup sequence is activated 408. Otherwise, the serial number and pin are read 410. If data transfer activity is detected 412, then the active I/O Port, Active Driver and Active Application are detected 414. Otherwise, if the data transfer activity is not detected 412, then the process starts 402.

After step 414, the data flow recording is initialized as an OpenNew Sequence of an encrypted image file (e.g., a *.DIV file) 416. The data header is written 418 and the encrypted data flow is written 420. The active I/O PORT, active Driver, Active Application is once again detected 422. If data transfer activity is detected 424, then the encrypted data is again written 420. Otherwise data transfer activity is not detected 424 and a parity check for the end of file is conducted 426.

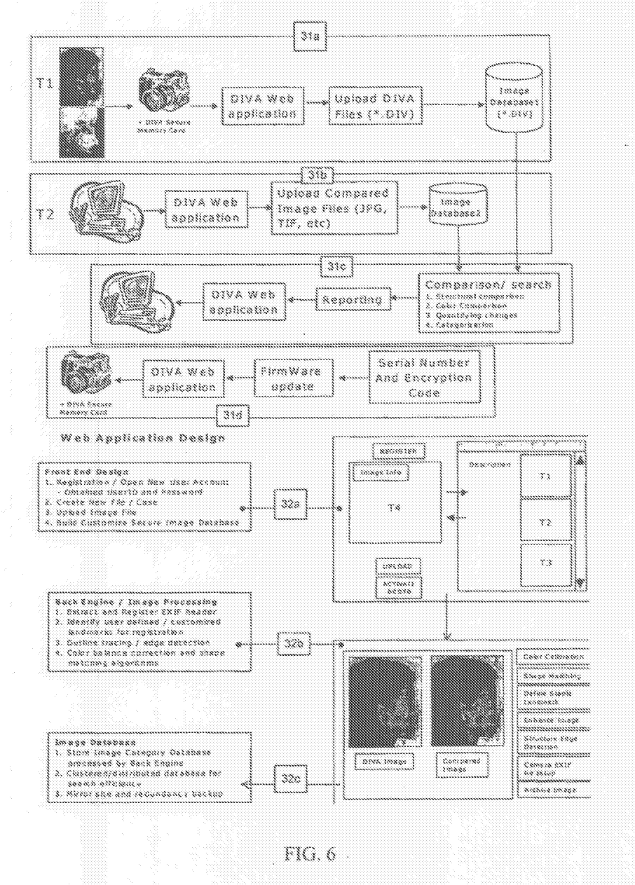

In FIG. 5, a flow diagram 500 illustrating decryption of encrypted digital images (e.g., *.DIV files) stored in the Compact Flash memory storage module of FIG. 1 is shown. The flow diagram 500 starts 502 with an attempt to open a DIV file containing encrypted image data 504. If the DIV file cannot be opened, then the process starts again 502. Otherwise, a PIN number is entered 506 and a check of parity for heading and end of file (EOF) is conducted 508.

If the parity check equals the serial number and pin 510, then the data header, active application, and active drive are read 512. Otherwise the data is determined to be corrupt and the file is not opened 514 and the process is ended 516.

After the data headers, active applications and active driver are read 512, calls are made to the application and the drivers occur 518 and the data flow is read 520. The decryption algorithm is activated 522 and the data flow is processed until the end of file 524. If the end of file is reached, then processing is complete 516. Otherwise 524, data is posted to the application and driver 526 and the data flow is read 520.

Turning to FIG. 6, DIVA web application 31a allows users to upload and decode the encrypted digital file (e.g., *.DIV) generated by the DIVA hardware/device as well as update the hardware firmware in certain embodiments of the DIVA hardware implementation. The DIVA web application 31a and its secured channel and server accept encrypted digital image data generated by a digital image captured hardware peripheral (camera, scanner, etc). The uploaded encrypted files are stored in “Image Database 1.” The DIVA web application 31b may be used to perform comparisons of an image to the encrypted “original” DIVA image stored in DIVA secured server database (Image Database 1). This digital image may be stored for processing in “Image Database 2.” The DIVA server 31c may have a built-in image comparison algorithm which can perform structural comparison, color comparison, quantifying changes and image categorization/databasing.

In certain embodiments of a DIVA hardware implementation (such as in a dongle, key, etc), the DIVA web server may also provide a firmware update via a firmware update module 31d allowing a DIVA web server to remotely update encryption algorithm on the DIVA hardware as well as serial number/PIN/encryption key.

DIVA web application GUI (front end) design 32a, allows users to register, upload DIVA files and compare images with DIVA files previously uploaded in the DIVA secured database. DIVA web application back engine 32b may store and analyze EXIF headers of digital images, perform image processing, and analyze structural and color changes. Statistical analysis may also be reported based on the findings of engine 32b. The image databases 32c (Image Database1 and Image Database2 —see 31a and 31b for details and functionality) store an image category database processed by the DIVA web application back engine 32b and a clustered/distributed database for search efficiency and a mirror site and redundancy backup.

In an alternative implementation of the present system, the digital image or data validation system includes a memory card configured to be used with an imaging device. The memory card includes a processor and memory for storing an encrypted copy of image data received from the imaging device. The data is encrypted using encryption key data or information accessible to a processor of the memory card and an encryption routine that is executed by the processor. As discussed above, the encryption routine may include security key algorithms such as the RSA algorithm (public key based), Data Encryption Standard (DES) and/or Advanced Encryption Standard (AES) (security key based) as set forth by NIST (National Institute of Standards and Technologies).

In the present implementation, only a single copy of data received from an imaging device is stored on the memory card as an encrypted file. Because only a single copy is stored, the memory card does not need to include additional circuitry configured to create a duplicate copy of any image data received from an imaging device. As such, the memory card may require less electrical energy to receive data from an imaging device and store an encrypted copy of the data. Furthermore, because only a single copy is stored, the capacity of the memory card may be increased over other implementations of the present system that call for duplicate copies of the same data (with one copy being encrypted and the other not encrypted).

After storing the encrypted copy of the image data, the memory card may be inserted into a computer or other device for reading the encrypted contents of the memory card. The encrypted contents of the memory card may then be uploaded via a website to a data warehouse for storing the encrypted data and viewing unencrypted image files. In the present implementation, the warehouse has records of the encryption key data or information used to encrypt the image files and allows a user to retrieve decrypted copies of the image data via the website and review the decrypted images to detect any changes or other anomalies.

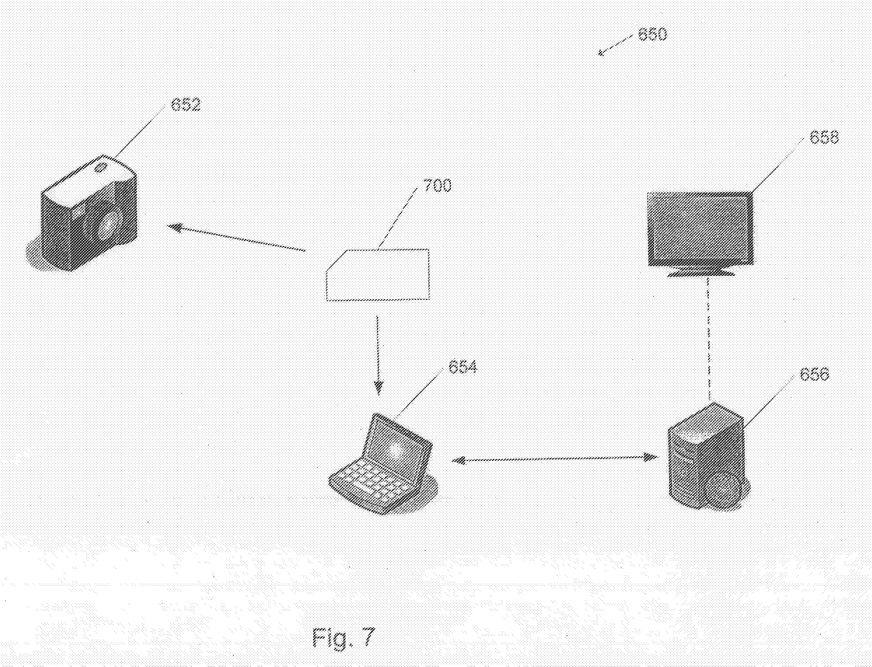

FIG. 7 is an illustration of a system for image validation including an image validation memory card, imaging device, computer system, and website. Memory card 700 may include a conventional form factor and is configured to connect to and communicate with imaging device 652 and computer 654. Memory card 700 receives image data from imaging device 652, encrypts the image data and stores the encrypted image data in a memory of memory card 700. After receiving and encrypting the image data, memory card 700 can be inserted into a computer to retrieve the encrypted image data therefrom. After receiving the encrypted image data, it can be uploaded to server 656, where the encrypted image data can be decrypted by server 656. After decryption, the image data can be displayed via user interface 658. In one implementation, user interface 658 includes a website displayed on a computer monitor.

Also using server 656, unencrypted copies of the image files can be downloaded using computer 654 for distribution to others. Before providing the unencrypted image files for download, however, server 656 creates a smaller version of the image file, encrypts it, and stores the encrypted image file as header data within the unencrypted image file. Alternatively, server 656 may encode a signature into the image containing a unique identifier for the image when stored within server 656. As such, the unencrypted image file can be distributed to others, but will include the encrypted header information containing a copy of the original image file or signature identifying the image. After they are retrieved, the unencrypted image files can be distributed to others for their review.

In one example, imaging device 652 includes a medical x-ray device. After performing an x-ray of a patient, the x-ray images are first captured and encrypted on memory card 700. The x-ray images or data may include raw x-ray data generated by an x-ray sensor. In other implementations, however, the x-ray data includes processed x-ray data and includes one or more images that have been generated using raw x-ray data. Memory card 700 is then inserted into computer 654 and the encrypted x-ray image files are retrieved from memory card 700 by a user. The encrypted x-rays images may then be uploaded to server 656 and server 656 decrypts the x-ray image files and prepares unencrypted copies of the x-ray image files. The unencrypted x-ray image files include header information containing an encrypted copy of the original x-ray image file. The unencrypted x-ray image files are then retrieved by a user using user interface 658 and can be distributed to others.

In the example, the user may retrieve the unencrypted x-ray image files from user interface 658 and submit the unencrypted x-ray image files to an insurance company for coverage. If the insurance company wishes to verify that the received images have not been altered after they were captured, the insurance company can upload the unencrypted x-ray image files to server 656 for verification.

Server 656 retrieves the encrypted header portion of the file after receiving the unencrypted x-ray image files from the insurance company, decrypts it and presents the decrypted image retrieved from the header information next to the unencrypted image file. The insurance company can then compare the unencrypted image file it received from the dentist to the image that was retrieved from the image's encrypted header information. If the images differ, the original image may have been modified or altered, possibly for the purposes of insurance fraud.

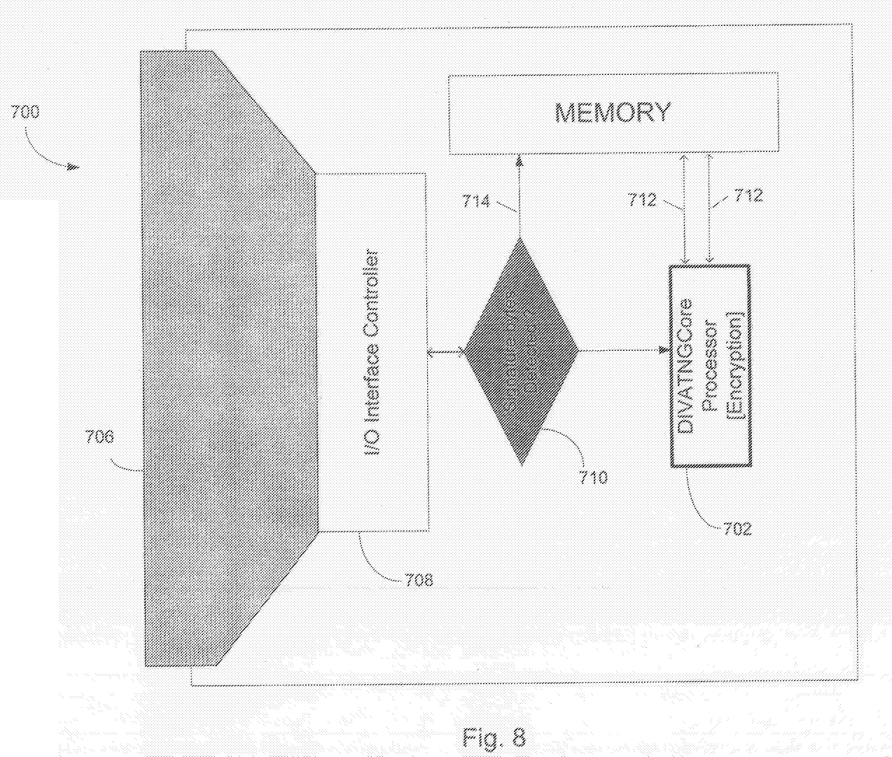

FIG. 8 is an illustration of some of the functional components comprising the present memory card. Memory card 700 may take any appropriate form factor for communicating with one or more image generating devices or devices configured to read data from memory card 700 (e.g., personal computers, or laptops). For example, memory card 700 may include a COMPACTFLASH, or SECURE DIGITAL form factor. Memory card 700 includes core processor 702 for executing the functionality of memory card 700. Processor 702 executes software for detecting when memory card 702 is in communication with an imaging or other device and the state of the imaging device (i.e., capturing, reviewing, or transferring), encrypting data received from an imaging device when the device is in picture taking mode and transmitting the encrypted data to computers or other devices configured to read data from memory card 700.

Core processor 702 may access encryption key data or information stored on memory card 700 for executing various encryption or decryption software routines. The encryption key data or information may be unique to memory card 700 and include a serial number, or a private key for use in a public key cryptography algorithm, for example. In many applications, the contents of the encryption key data is not known to a user of memory card 700 and is only accessible to core processor 702. The encryption key data may be stored in memory 704, within core processor 702, or elsewhere on memory card 700 where the key data is accessible to core processor 702.

Core processor 702 communicates with memory 704 to store and retrieve encrypted image data. In some implementations, core processor 702 may also be configured to store unencrypted data that is received from a computer or other non-imaging device. Memory 704 may include non-volatile electronic memory such as flash or other electrically erasable programmable read only memory (EEPROM). Alternatively, memory 704 may include volatile memory, such as random access memory (RAM), or combinations of volatile and non-volatile memory.

Memory card 700 includes connector 706 for interfacing with one or more external system components. Connector 706 may include SCSI, Parallel, Serial, USB, or Firewire connectors, for example. In some embodiments, connector 706 is replaced with a wireless communication interface. Connector 706 is connected to interface controller 708 for receiving and transmitting data. Interface controller 708 may include a processor, integrated circuit (IC), or other electronic circuitry for allowing core processor 702 to communicate with external system components using connector 706.

As shown in FIG. 8, memory card 700 is configured to implement logic to determine whether to encrypt data received via connector 706 and to store that encrypted data in memory 704. As such, FIG. 8 illustrates logic statement 710 that may be executed by core processor 702. In logic statement 710, core processor 702 monitors and analyzes electronic communications received via connector 706 from one or more external components. If core processor 702 detects a particular predetermined signal or type of signal, core processor 702 executes one or more encryption routines to encrypt data received from the imaging device via connector 706 and store the encrypted data in memory 704 (illustrated by communication arrows 712). If, however, the signal is not detected, core processor 702 may be configured to store data received from connector 706 as unencrypted data in memory 704 (illustrated by communication arrow 714), thereby bypassing the encryption routines of core processor 702, or to deny write access entirely.

Depending upon the system implementation, the pre-determined signal may be used to detect when memory card 704 is connected to and receiving data from an imaging device, indicating that the data received via connector 706 is image data and should be encrypted before storage. The signal may include, for example, a particular collection of bits that an imaging device transmits before sending image data to memory card 700. As discussed above, in one implementation, the signal includes a particular instruction sent by an imaging device as the imaging device attempts to access a particular file system structure (e.g., a request received from the imaging device as it attempts to determine whether the file system structure ROOT/DCIM/AAAA#### exists). In another implementation, medical imaging devices may be configured to transmit a particular signal or electronic signature through connector 706 before sending data that must be encrypted before storage, whether because the data contains sensitive patient data, or because the data includes data that will be used for insurance payment or other legal purposes.

In one implementation of the present system, the digital imaging device includes a digital camera such as a NIKON D50 digital SLR camera. In accordance with certain design rules (e.g., the Design Rule for Camera File System Version 1.0 JEIDA-49-2-1998), at power-up, whether the camera is in picture-taking or picture-reviewing mode, the digital camera sends a pre-determined signal to request the DCF (digital camera file) folder and file structures present on the media. The pre-determined signal may be used by the memory card of the present system to determine whether to encrypt digital image data received from the digital camera and also to determine what access rights to grant to the device attached to the memory card. If the folder with naming convention pertaining to that specific camera is not present, the digital camera will attempt to create a folder with the required folder name.

If, for example, the camera is in picture-taking mode, the camera may send a signal requesting the names of all folders present in the root of any memory card connected to the camera. If a folder named “DCIM” is present, the camera may read into the folder and request the names of sub-folders present in the folder name “DCIM”. If a DCF folder named, for example, “100NCD50” or “101NCD50” is present, the camera may read into the folder to request all the names of all folders and basic image files present in that folder. If the first DCF folder (e.g., “100NCD50”) has over 9999 DCF file objects with DSC_#### (such as DSC_1234.JPG, DSC_9988.JPG) names, the camera may query into the next DCF folder (e.g., “101 NCD50”) until the camera can locate a folder with available DCF file names for storage.

If the memory card is empty, or when the root folder of the memory card does not contain a “DCIM” folder, the camera may attempt to create DCIM folder at the root level of the media.

If, however, a folder named “DCIM” is present but does not contain the DCF folder with the first usable name (e.g., for a NIKON D50 digital camera, “100NCD50”), the camera will attempt to create such folder.

If a “DCIM\100NCD50” DCF folder structure is present but contains more than 9999 DCF objects with DSC_#### names, the camera may try to create a new DCF folder under DCIM with the next available DCF folder name, such as “101NCD50”. As such, any of the above-described signals involving the camera negotiating a pre-determined file system and/or creating files and/or folders within that file system may be designated the pre-determined signal and used to trigger the memory card to encrypt image data received from the device.

When reviewing images stored on the memory card, the connected digital camera (e.g., a NIKON D50 digital SLR camera) may attempt to read through all the file structures on the media to locate a folder named “DCIM” and any sub-folder within the DCIM folder pertaining to the camera's DCF naming convention. If such DCF folders can be located, the digital camera may query the folder to list all DCF file objects inside that folder.

If none of the DCF folders or files can be located, the digital camera will not try to create a DCF structure. Other cameras, however, may attempt to create a DCF folder structure containing no files if the structure can't be located.

In one implementation, when implementing USB file transfer mode using the memory card of the present system, no such DCF file locating operations may be processed. In that case, the camera attempts to function as a USB memory card reader. The computer that the camera is connected to may request the file/folder structure information, but not the DCF structure. A system operating in USB file transfer mode may be identified by the initial disk initialization process that occurs when the camera is connected to a computer via USB, Firewire, or, for example, eSATA. This prevents hackers from writing codes to simulate the folder locating operations in picture taking mode.

Certain printers and picture players have the ability to read into the media card and play the digital images inside the DCF folders. Most printers function as a general reader for the media card as in the USB file transfer mode systems described above. Other printers, however, may work in a similar fashion as a digital camera operating in picture review mode.

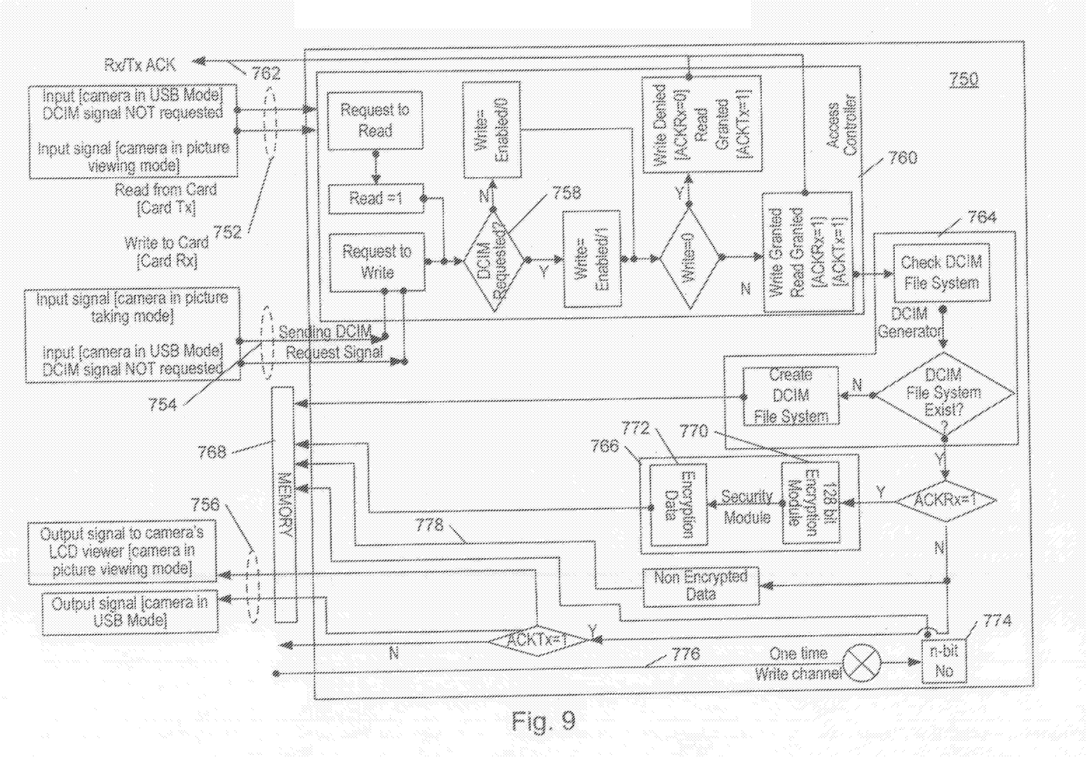

FIG. 9 is a schematic diagram showing additional detail of the components of an exemplary core processor 750 of the present DIVA memory card 700. Core processor 750 includes three primary data transfer busses that are configured to communicate via connector 706 (shown on FIG. 8). Read bus 752 receives requests from external devices to read memory card 700 data. The external devices may include digital cameras, computers, or other external system components configured to communicate using connector 706. Write bus 754 receives requests from external components to write data to memory card 700. Output bus 756 transmits data to external system components.

Using read bus 752, memory card 700 receives requests from external system components to read data from memory card 700. The read requests may be issued by connected digital imaging devices, for example. In that case, the request may be made by an imaging device in picture taking mode and may include a DCIM request signal, or other signal identifying the device as a digital imaging device. Alternatively, the request may be made by a computer, or other device that is configured to read data from memory card 700 and does not send a signature signal to memory card 700 or an imaging device that does not transmit DCIM request signals when reading data from memory card 700.

After receiving the read request, core processor 750 is configured to verify whether the signature signal was detected in decision block 758. If the signal is detected, the connected device is given write access by access controller 760. Access controller 760 may also be configured to transmit a signal to the connected device using bus 762 to inform the connected device of the connected device's write privileges.

After receiving the read request using read bus 752, DCIM generator 764 verifies that a DCIM filesystem exists on memory card 700. If not, DCIM generator 764 creates a DCIM file system in memory 768. After verifying that the DCIM file system exists, controller 750 may retrieve the requested data from memory 768 and transmit the data to the external device using output bus 756.

Controller 750 may also receive a write request and associated data through write bus 754. After receiving the write request, controller 750 verifies that the write request includes a pre-defined signal (e.g., a DCIM request signal) in block 758. If the signal is detected, write access may be granted. If the signal is not detected, write access is not granted and the request may be ignored or memory card 700 may transmit an error message to the external device.

If write access is granted, processor 750 verifies that a DCIM file structure is present using DCIM generator 764. After verifying that the DCIM file structure exists in memory 768, or after generating such a file structure in memory 768, the data associated with the write request is transmitted to security module 766 to be stored as encrypted data in memory 768. Security module 766, uses encryption module 770 to generate encrypted data 772 which is stored in memory 768. In one implementation, security module 766 retrieves n-bit number 774 to be used as an encryption key when encrypting and storing the data. In some cases, for example when memory card 700 is configured to operate as a conventional storage medium, processor 750 may store unencrypted data using unencrypted storage bus 778.

As discussed above, each memory card 700 may be associated with a unique encryption key. A unique key for processor 750 may be assigned and stored in memory card 700 using one time write channel 776 to store an encryption key in n-bit number storage location 774.

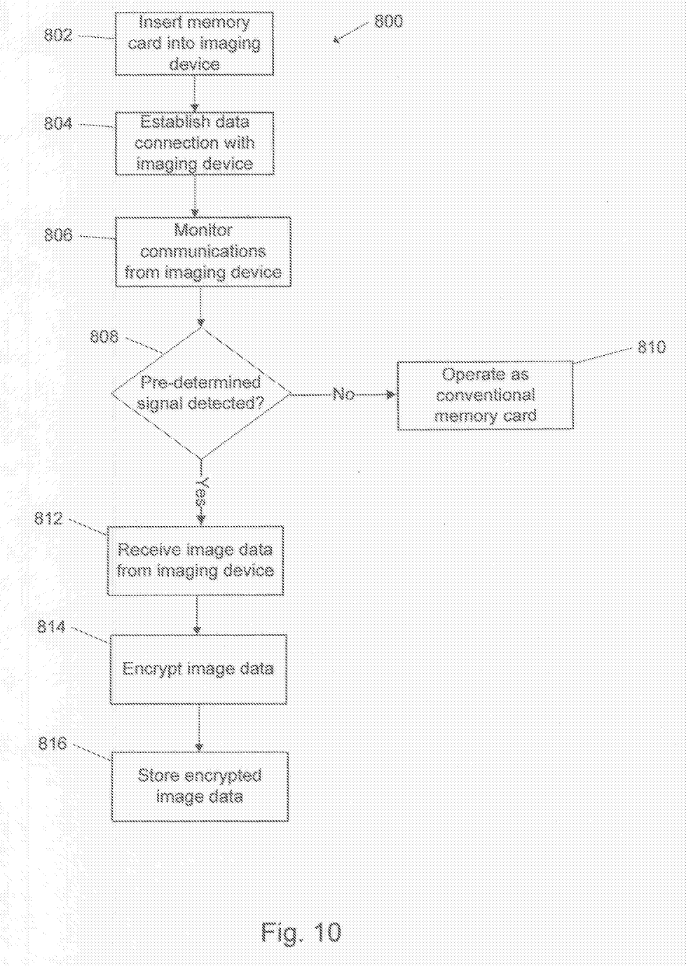

FIG. 10 is a flowchart showing an example method for interfacing the present memory card with a device to receive image data and store encrypted image data within the memory card. In step 802, memory card 700 (see FIG. 8) is physically connected to a device using connector 706. After inserting memory card 700, core processor 702 of memory card 700 establishes a connection with the device using interface controller 708 in step 804.

After establishing the connection, core processor 702 monitors communications received from the device in step 806 to determine whether memory card 700 is connected to an imaging device or to another type of device configured to connect to connector 706. Accordingly, in step 806, core processor 702 looks for a pre-determined signal, as discussed above. In decision block 808, core processor 702 evaluates whether the pre-determined signal is detected.

If the signal is detected, the presence of the signal indicates that memory card 700 is connected to an imaging device and will receive imaging data via interface controller 708 and that the imaging data will be encrypted before being stored on memory card 700.

If, however, core processor 702 does not detect the pre-determined signal, memory card 700 is not connected to an imaging device. In that case, in step 810, memory card 700 may operate as a conventional memory card allowing data to be read from the card, while disallowing any write or delete access to memory card 700. Alternatively, core processor 702 may allow new data to be written to memory card 700, while disallowing any deletion of encrypted data stored in memory 704 of memory card 700. In another implementation, when memory card 700 is connected to a non-imaging device (indicated by a lack of the pre-determined signal), memory card 700 allows a user full access to the memory card thereby allowing read, delete, and write access to the entire memory device.

If memory card 700 is connected to an imaging device (i.e., the pre-determined signal is detected), core processor 702 monitors interface controller 708 to analyze data received via connector 706 from the imaging device to identify and capture any image data received from the imaging device. In step 812, memory card 700 receives image data from the imaging device. After receiving the image data, core processor 702 encrypts the image data using an encryption algorithm as described above. To encrypt the image data, core processor 702 retrieves the encryption key data or information. The encryption key data or information may include a serial number, or a private key for use in a public key cryptography algorithm, for example. Core processor 702 then uses both the encryption key and image data as inputs to an encryption algorithm for encrypting the image data. The image data is encrypted in step 814 and then the encrypted image data is stored in memory 704 of memory card 700 in step 816.

After executing the method illustrated in FIG. 10, image data received from an imaging device connected to connector 706 of memory card 700 is encrypted and stored in memory 704. Although the encrypted data can be retrieved from memory card 700 by connecting the card to a computer or other device configured to retrieve data from memory card 700 (see step 810 of FIG. 10), the encrypted image data cannot be decrypted by the user after the encrypted data is retrieved. As described above, the data is encrypted using encryption key data or information known to core processor 702, but not accessible to a user. As such, the user cannot edit or otherwise modify the images. To view the images, or to verify the image's authenticity, the encrypted image files are uploaded to a website allowing the user to initiate decryption of the files, perform comparisons, and download decrypted image files that include an encrypted image signature as part of a header portion of the unencrypted images.

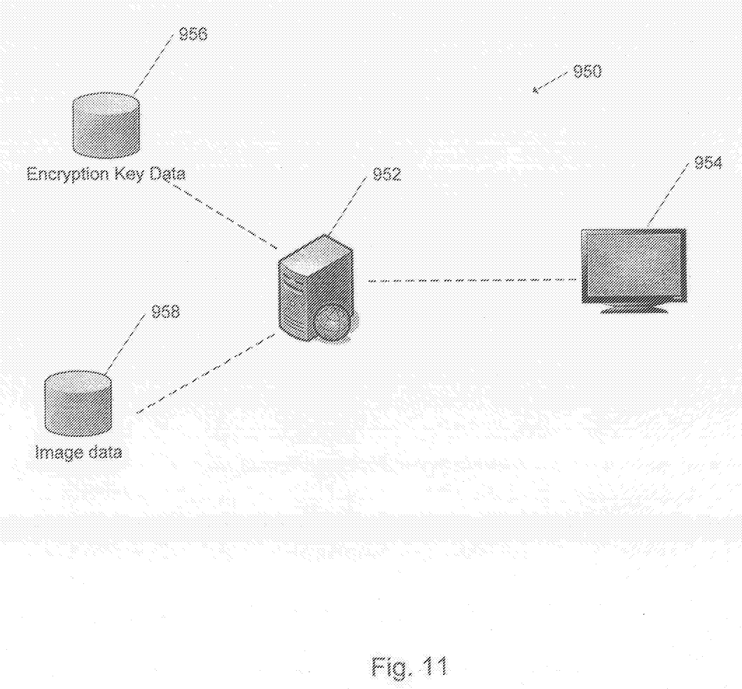

FIG. 11 is an illustration of an exemplary data warehouse infrastructure for receiving encrypted image files, decrypting the image files, and displaying comparison images for a user to verify whether a particular image has been modified. Warehouse system 950 includes server 952 for communicating with a computer operated by a user. Server 952 can receive encrypted image files from a user and transmit unencrypted image files to a user. Generally, server 952 communicates with a user using user interface 954 which, in the present implementation, includes a website.

Server 952 communicates with encryption key database 956 for retrieving the data necessary to encrypt and decrypt data received from a user via user interface 954. If the encryption keys are different for each memory card, encryption key database 956 stores the encryption keys and associates each encryption key with identification information for each memory card.

Server 952 may also communicate with image database 958 to store encrypted image data received from a user via user interface 954.

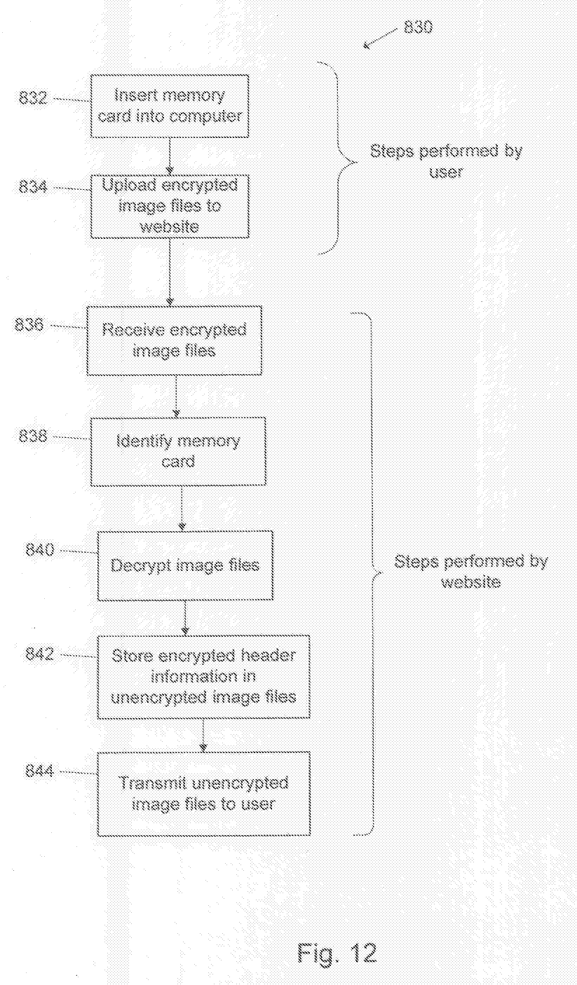

FIG. 12 is a flowchart showing an example method 830 for a user to retrieve encrypted image files from the memory card of the present disclosure and upload the encrypted image files to a website for decryption. In step 832 the user inserts memory card 700 into a computer or other device for retrieving the encrypted image files. Because the device is not an imaging device such as a camera, scanner, or medical imaging device, memory card 700 does not detect an imaging device signature signal and enters a read-only mode in which files can be retrieved from memory card 700, but no data can be stored on memory card 700 and the encrypted image files cannot be deleted. In step 834, after inserting the memory card, the user retrieves one or more of the encrypted image files from memory card 700 and uploads them to the website.

After receiving the encrypted image files from the user in step 836, the website may initiate decryption of the encrypted image files. Because, as discussed above, each memory card 700 may be assigned unique encryption key data, the website must first identify the memory card 700 from which the encrypted data has been retrieved in step 838.

In one embodiment, core processor of memory card 700 is configured to include meta data with each encrypted image file to identify the memory card 700. The meta data may include a serial number or other unique information identifying the memory card 700. For example, a user may go through a registration process before using memory card 700. In that case, the meta-data may include a username, account number, or other information created during the registration process that identifies memory card 700.

After identifying memory card 700 in step 838, the website receives the necessary decryption key data from a key database and initiates decryption of each of the encrypted image files received from the user in step 840. After decrypting the image files in step 840, the website may be configured to insert encrypted header information into the decrypted image files allowing for future authentication of the image files.

For example, in one implementation, in step 842, the website generates a smaller version of the decrypted image file which is then encrypted and stored in the header information of the decrypted image file. The smaller version may be generated by decreasing a size of the image, decreasing a resolution of the image, decreasing a dots per inch (DPI) of the image, rendering the image in black and white, or any combination thereof, for example. After generating the reduced-size image file, that image file is again encrypted using the memory card's encryption key data and inserted into the header information of the decrypted image file.

After decryption in step 840, and insertion of the header information in step 842, the decrypted image file (including the new header information) may be transmitted to a user via a website interface. The user then has access to an unencrypted version of the image file which can be sent to others, printed, or otherwise viewed on a conventional computer viewing system. Additionally, the unencrypted image file includes a header containing an encrypted version of the original image.

The unencrypted image file can then be sent to various people and/or organizations for their review. Using the header information, each recipient of the unencrypted image file can transmit the unencrypted image file to the website to verify that the unencrypted image file contains an unedited or otherwise unmodified image.

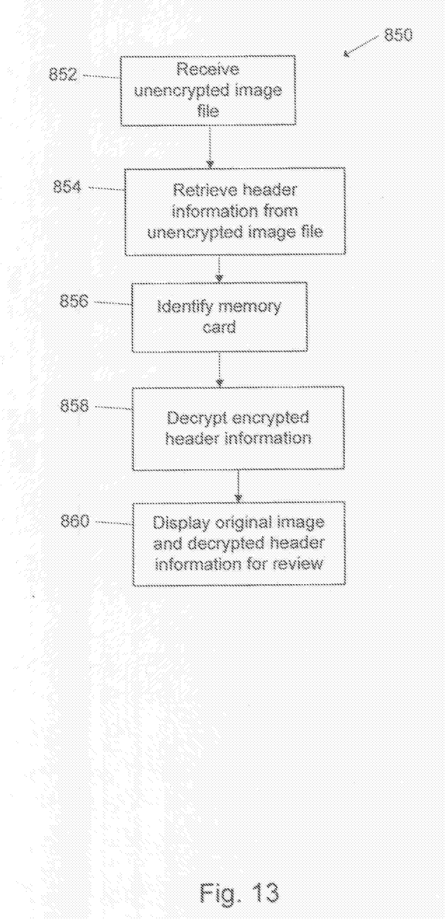

FIG. 13 is a flowchart showing an example method 850 for verifying the authenticity of an unencrypted image file created using the method of FIG. 10. In step 852, a user uploads an unencrypted image file to the website after retrieving the file from memory card 700. The unencrypted image file includes the image data as well as header information stored in the unencrypted image file. The header information may include the encrypted image file stored in step 842 of FIG. 12, for example, as well as information that identifies the original memory card 700 upon which the image was originally stored.

In step 854, after receiving the unencrypted image file, the header information is retrieved from the unencrypted image file. Using the header information, the website identifies memory card 700 that originally stored the image file in step 856. After identifying memory card 700, the website can retrieve the decryption key data for that particular memory card and decrypt the encrypted header information.

After the encrypted header information is decrypted in step 858, the website displays both the original image received in step 852 and the image decrypted in step 858 for the user. The user can then compare the images to determine whether the image has been altered or otherwise manipulated.

As discussed above, the website may provide the user with tools for analyzing both images to detect discrepancies that are difficult to identify with the human eye. For example, the website may provide tools for performing a structural comparison or performing a color comparison, quantifying any changes between the images, and categorizing the images. Using these tools, the user can quickly detect any discrepancies between the two images to determine whether the images have been tampered with or otherwise modified.

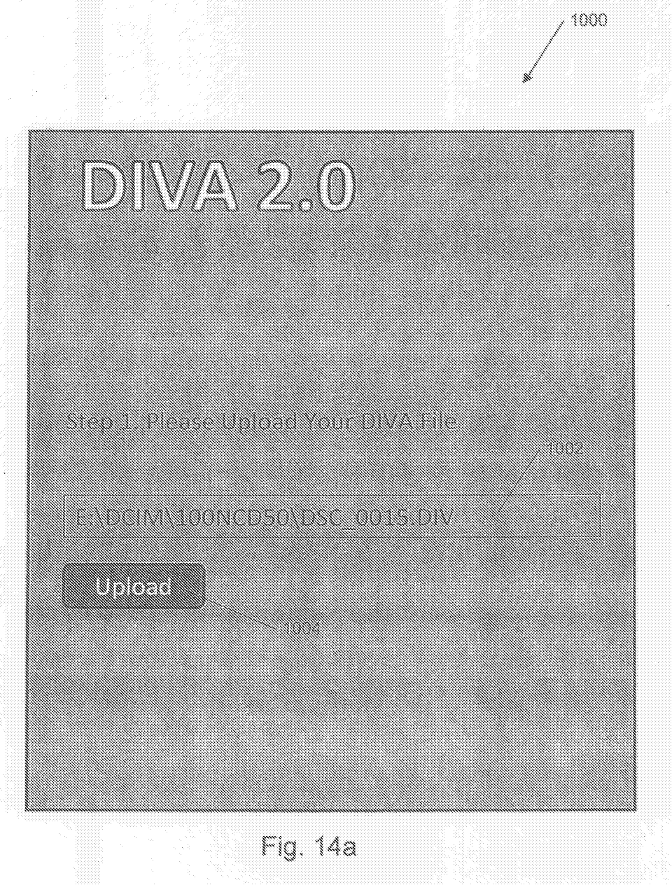

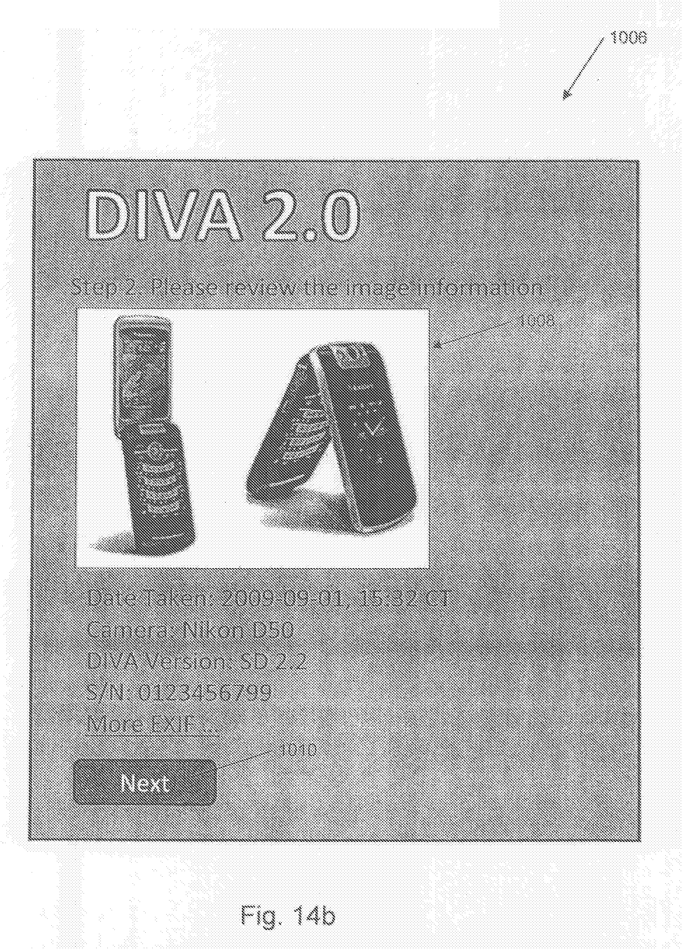

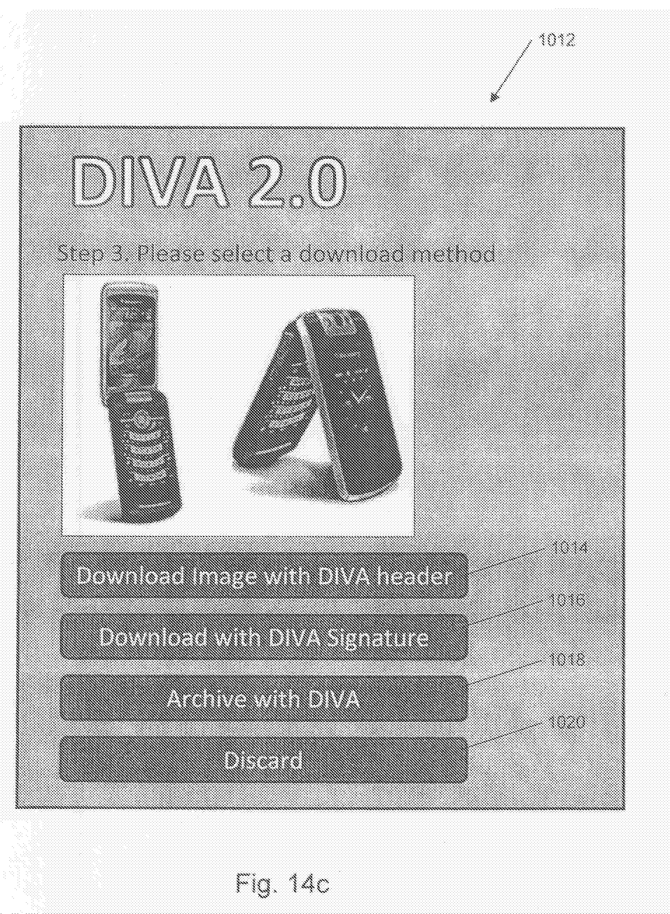

FIGS. 14a-14c illustrate a user interface allowing a user to upload an encrypted image file to a data warehouse infrastructure, such as the warehouse illustrated in FIG. 11. The user interfaces may be supplied via a website hosted using the data warehouse, or provided by another third party system. Alternatively, the user interface may be provided by a software application running on a computer operated by the user. The user interface may also be supplied by the digital imaging device itself. For example, the digital imaging device may be configured to communicate directly with the data warehouse to uploaded and retrieve files. In that case, the digital imaging device may provided the user interface to provide the functionality of the system.

In FIG. 14a interface 1000 includes a file upload dialog box 1002 allowing a user to specify a particular file to uploaded to the data warehouse. The file includes an encrypted file generated using the memory card of the present system. The file may reside on the memory card and be accessed, for example, using a USB file transfer mode of a connected computer. Alternatively, the file may be have been copied from the memory card onto another storage device of the computer. After specifying the file to be uploaded, the user uses button 1004 to initiate the upload process.

After the upload is complete, the data warehouse system decrypts the uploaded file using the method illustrated in FIG. 12. After decryption the decrypted image is display in window 1008 of user interface 1006 illustrated in FIG. 14b. In addition to the showing the image, the system retrieves relevant EXIF information and displays it via user interface 1006. After verifying that the correct image is displayed and that the EXIF data is accurate, the user may use button 1010 to advance to the next screen where various image files can be downloaded.

User interface 1012 shown in FIG. 14c allows a user to retrieve various versions of the uploaded image file. Button 1014 allows a user to download a version of the image file having an encrypted header portion. For example, the user may download the original JPEG or TIFF image with a header having an encrypted portion. The encrypted portion of the header includes an encrypted copy of a smaller version of the original image and may be used to verify the authenticity of the downloaded file. Button 1016 allows a user to download a version of the image file having a signature in accordance with the present system. For example, the user may download the original image having a watermark or signature that includes an identification number to associate the image with a file stored within the data warehouse. The identification number contained in the watermark may later be used to retrieve the original copy of the image to verify authenticity. Button 1018 allows a user to archive a copy of the uploaded image file with the data warehouse. As such, rather than download a copy of the image, the user can store the images on the data warehouse for future use. For example, a copy of the uploaded file may be stored in image database 958 as shown in FIG. 11. Finally, button 1020 allows the user to cancel the process and discard the originally uploaded image file.

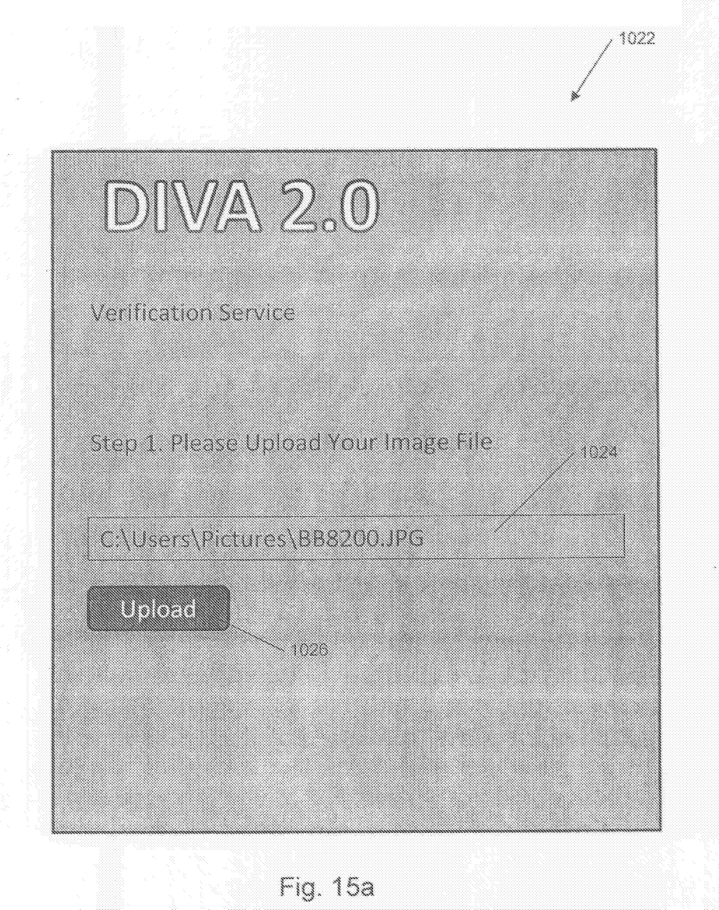

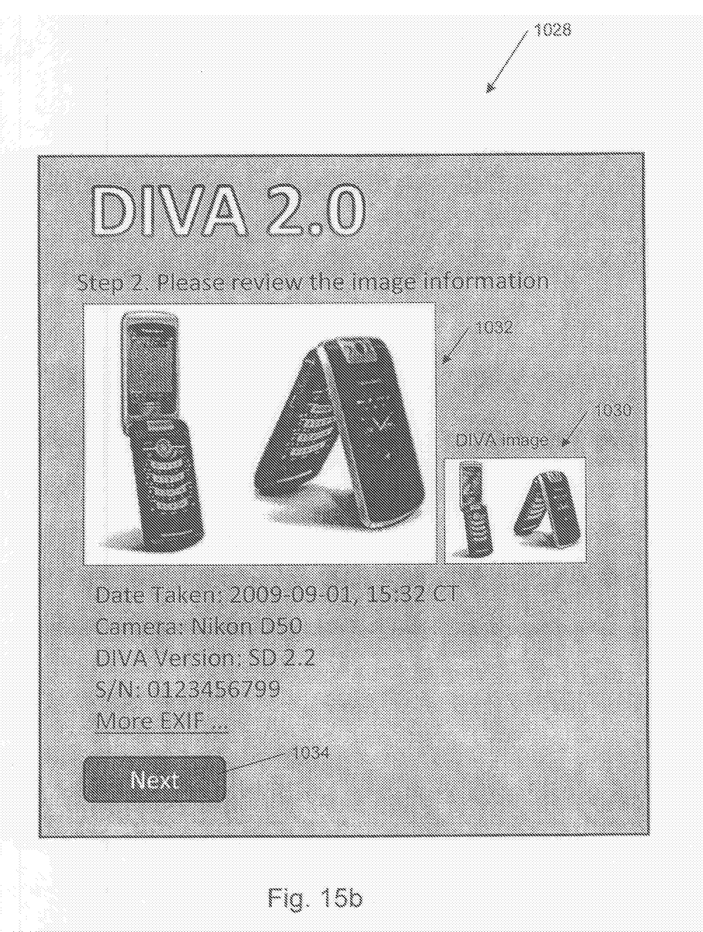

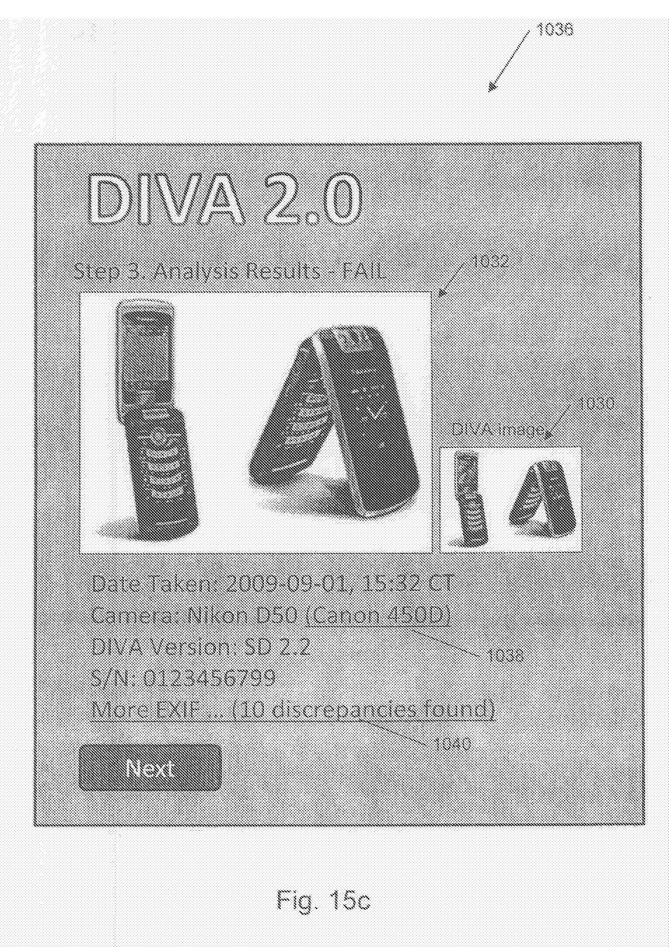

FIGS. 15a-15c illustrate a user interface for uploaded an image to verify the authenticity of the image. FIG. 15a illustrates user interface 1022 allowing a user to upload an image file that was originally generated using the present system. User interface 1022 includes a file upload dialog box 1024 allowing a user to specify a particular image file to uploaded to the data warehouse. The file may reside on the memory card and be accessed, for example, using a USB file transfer mode of a connected computer. Alternatively, the file may be have been copied from the memory card onto another storage device of the computer. After specifying the file to be uploaded, the user uses button 1026 to initiate the upload process.

After uploading the image file, the system verifies that the image contains either encrypted header information, or a watermark that contains an ID allowing the image to be associated with an image stored within the data warehouse. If neither encrypted header information nor the signature are detected, the system may display a warning informing the user that the image is invalid and cannot be authenticated.

After uploading the image, the system either retrieves the encrypted header information or the ID contained within the image's watermark. If the image file contains encrypted header information, the encrypted header information is decrypted and the resulting image is displayed in window 1030 next to the original uploaded image file in window 1032. Similarly, if the uploaded image contains a watermark having an ID, that ID is used to retrieve the original image file, for example from image database 958 of the data warehouse 950 of FIG. 11 and may be displayed in window 1030. Any available EXIF information may be retrieved from the uploaded image and displayed for review by the user.

User interface 1028 also includes button 1034 allowing a user to initiate an image comparison.

FIG. 15c shows user interface 1036 after a user has initiated an image comparison between the uploaded image and the original image. As shown in FIG. 15c differences in the EXIM data (elements 1038 and 1040) may be highlighted. Furthermore, any differences in the images may be highlighted in window 1030, 1032, or both.

In other implementations of the present system, the memory card may be configured to store and encrypt data received from other data sources in addition to imaging devices. For example, the memory card may be inserted into an audio recording device, data sensor, accounting system, cash register, or any other device that is configured to store data. If the device is configured to send a pre-determined signal to the memory card to indicate that any data received by the memory card should be encrypted before storing, the memory card may be used to store data received from the device (whether including image data or not), and encrypt the data ensuring that the data cannot be tampered with or otherwise modified. In still other implementations of the present system, the memory card may be configured to encrypt all data received from any connected device. As such, the memory card may be used to encrypt all data stored on the memory card.

The foregoing description of an implementation has been presented for purposes of illustration and description. It is not exhaustive and does not limit the claimed inventions to the precise form disclosed. Modifications and variations are possible in light of the above description or may be acquired from practicing the invention. For example, the described implementation includes software but the invention may be implemented as a combination of hardware and software or in hardware alone. Note also that the implementation may vary between systems. The claims and their equivalents define the scope of the invention.

Other systems, methods, features and advantages of the invention will be or will become apparent to one with skill in the art upon examination of the following figures and detailed description. In another embodiment of this invention, the DIVA server application may also act to update the Firmware embedded in the DIVA secure memory card to update either it's encryption algorithm, security key or unique encryption key. It is intended that all such additional systems, methods, features and advantages be included within this description, be within the scope of the invention, and be protected by the accompanying claims.

What is claimed is:

1. A method of digital image validation, comprising:
receiving a data stream from a digital imaging device;
analyzing the data stream to detect a pre-determined signal from the digital imaging device; and
when the pre-determined signal is detected in the data stream:
retrieving digital image data from the data stream,
encrypting the digital image data to generate encrypted digital image data, and
storing the encrypted digital image data on a storage medium.

2. The method of claim 1, including, when the pre-determined signal is not detected in the data stream:
at least one of:
disabling write access to the storage medium, and
disabling an encryption module in electronic communication with the storage medium, and
enabling read access to the storage medium.

3. The method of claim 1, including the step of compressing the digital image data.

4. The method of claim 1, wherein the step of encrypting the digital image data includes using a unique serial number of the storage medium.

5. The method of claim 4, wherein the unique serial number is stored in a one time write memory device.

6. The method of claim 1, wherein the digital image data includes x-ray data, the x-ray data including at least one of raw x-ray data and processed x-ray data.

7. The method of claim 1, wherein the pre-determined signal includes a folder-locating signal.

8. The method of claim 7, wherein the folder-locating signal includes a request for a digital camera images (DCIM) file structure.

9. A memory card, comprising:
a storage medium for storing data; and
a processor electronically coupled to the storage medium, the processor being configured to:
receive a data stream from a digital imaging device;
analyze the data stream to detect a pre-determined signal from the digital imaging device; and
when the pre-determined signal is detected in the data stream:
retrieve digital image data from the data stream,
encrypt the digital image data, and
store the encrypted digital image data on the storage medium.

10. The memory card of claim 9, wherein the processor is further configured to, when the pre-determined signal is not detected in the data stream:
at least one of:
disable write access to the storage medium, and
disable an encryption module within the memory card, and
enable read access to the storage medium for retrieval of the encrypted digital image data.

11. The memory card of claim 9, wherein the digital image data includes x-ray data, the x-ray data including at least one of raw x-ray data and processed x-ray data.

12. The memory card of claim 9, wherein the pre-determined signal includes a folder-locating signal.

13. The memory card of claim 12, wherein the folder-locating signal includes a request for a digital camera images (DCIM) file structure.

14. A digital imaging system, comprising:
a digital imaging device, the digital imaging device being configured to transmit a pre-determined signal; and
a storage device configured in electrical communication with the digital imaging device, the storage device including:
a storage medium for storing data, and
a processor electronically coupled to the storage medium, the processor being configured to:
receive a data stream from the digital imaging device,
analyze the data stream to detect a pre-determined signal from the digital imaging device, and
when the pre-determined signal is detected in the data stream:
retrieve digital image data from the data stream,
encrypt the digital image data, and
store the encrypted digital image data on the storage medium.

15. The digital imaging system of claim 14, wherein the processor is configured to, when the pre-determined signal is not detected in the data stream:
at least one of:
disable write access to the storage medium, and
disable an encryption module within the storage device, and
enable read access to the storage medium for retrieval of the encrypted digital image data.

16. The digital imaging system of claim 14, wherein the processor is configured to compress the digital image data before encrypting the digital image data.

17. The digital imaging system of claim 14, wherein the digital image data includes x-ray data, the x-ray data including at least one of raw x-ray data and processed x-ray data.

18. The digital imaging system of claim 14, wherein the pre-determined signal includes a folder-locating signal.

19. The digital imaging system of claim 18, wherein the folder-locating signal includes a request for a digital camera images (DCIM) file structure.

20. The digital imaging system of claim 14, wherein the digital imaging device includes a digital camera.
